(19) United States
(12) Patent Application Publication
(10) Pub. No.: US 2013/0078069 A1
(43) Pub. Date: Mar. 28, 2013

(54) Tilt Mechanism for Interchangeable Scoop and Plow Assemblies

(71) Applicant: Michael P. May, Wamego, KS (US)

(72) Inventor: Michael P. May, Wamego, KS (US)

(73) Assignee: CATERPILLAR, INC., Peoria, IL (US)

(21) Appl. No.: 13/242,436

(22) Filed: Sep. 23, 2011

(51) Int. Cl. E02F 3/38; B23P 17/00

(52) U.S. Cl. 414/697; 29/401.1

(57) ABSTRACT

A scoop assembly is disclosed for a wheel dozer. The scoop assembly includes a frame that includes right and left lift arms that may be coupled together by a distal cross beam. The lift arms include proximal portions that extend between the two cross beams and a distal hook-shaped portion that extends forward beyond the distal cross beam. The distal hook-shaped portions pivotally connect to the bucket. The distal cross beam provides a place for the location of a bracket that supports a single dump cylinder that extends upward into a central pocket disposed in the back of the bucket. The dump cylinder is protected from debris due to its raised position and placement inside a centralized pocket that does not experiment the flow of debris materials.

### TECHNICAL FIELD

This disclosure relates generally to wheel dozers, and more specifically to wheel dozers designed for dozing and loading lighter materials such as woodchips and coal. Still more specifically, this disclosure relates to an improved tilt mechanism for interchangeable scoop and dozer assemblies that employ a common frame.

### BACKGROUND

It is common practice to mount a bucket or blade to the front of a wheel dozer by a pair of lift arms. Each lift arm may be spaced from one another a distance that is slightly narrower than the width of the bucket. The lift arms and the bucket are normally raised and lowered by a pair of lift cylinders that are connected to each lift arm or a crossbeam that connects the two lift arms together. Dump cylinders for the bucket are provided that are connected between the lift arms and the bucket. The bucket may be filled or dumped by actuating the pair of dump cylinders to pivot the bucket with respect to distal ends of the lift arms. The combination of the lift arms, lift cylinders, linkages, dump cylinders and bucket will be referred to herein as a “scoop assembly”.

Some wheel dozer buckets are specifically designed for moving and stockpiling lighter materials, such as coal, woodchips and other low density materials. The buckets increase production by being able to both doze and carry a load. Of course, different sizes of buckets are available for different machines and for different materials.

One problem associated with current designs for wheel dozer equipped with a bucket and linkages designed for loading lighter materials is the exposure of the dump cylinders to the lighter materials. Specifically, the woodchips and/or coal can become packed between the dump cylinders and the bucket or between the dump cylinders and the lift arms, which can cause cylinder damage and potential failure. If one of the dump cylinders fails, the second dump cylinder may be prone to binding and premature failure.

Another problem associated with current bucket designs for lighter materials relates to the center of gravity of current bucket designs. Specifically, current bucket designs have a center of gravity that may be disposed a substantial distance from the wheel dozer and low to the ground thereby requiring the wheel dozer to provide a substantial amount of torque in order to lift the bucket.

Some wheel dozer include a tilt function which enables the bucket and the lift arms to tilt to the left or right or about a longitudinal axis that passes between and parallel to the lift arms. One tilt function may be provided by a tilt cylinder, one end of which may be mounted directly or indirectly to the wheel dozer and the other end of which may be mounted to one of the lift arms. Retraction or extension of the lift cylinder causes the frame formed by the lift arms and cross beams to tilt to the right or left, dependent upon which arm the tilt cylinder is connected to. Other tilt functions are provided by special bearing and linkage arrangements disposed between the work tool and the frame. See, e.g., U.S. Pat. No. 6,269,561. Because currently available buckets for light weight materials are also used for dozing which may require a tilt range that is broader than the currently available range of 2°-3°, additional tilting capabilities are desired.

Further, because buckets for light weight materials are generally not that versatile, it would be beneficial to have a quick and easy lift arm and linkage arrangement which would enable a bucket to be quickly and easily replaced with a blade or similar tool. Finally, current bucket designs for light weight materials typically include a lower cutting edge for facilitating dozing operations. Unfortunately, many current bucket designs for light weight materials place the cutting edge too low are too far below the surface when the bucket is in the dump position, thereby putting undue strain on the wheel dozer when combining dumping and dozing operations.

### SUMMARY OF THE DISCLOSURE

A tiltable frame for a combination scoop and dozer system is disclosed. The frame includes right and left lift arms. Each lift arm may include a proximal end and a distal end. The right and left lift arms may be coupled together by a distal cross beam disposed between the proximal and distal ends of the lift arms. The proximal ends of the right and left lift arms may be coupled to a fixed proximal cross beam. The tiltable frame may also include right and left tilt cylinders, right and left tilt levers and right and left cylinder brackets. The right tilt lever may be pivotally coupled to the proximal end of the right lift arm. The left tilt lever may be pivotally coupled to the proximal end of the left lift arm. The right cylinder bracket may be coupled to the right lift arm between the proximal and distal ends thereof. The left cylinder bracket may be coupled to the left lift arm between the proximal and distal ends thereof. The right tilt cylinder may be coupled to the right tilt lever and the right cylinder bracket while the left tilt cylinder may be coupled to the left tilt lever and the left cylinder bracket. The right and left tilt levers may be coupled to right and left bearings. The proximal cross beam may include right and left ends, wherein the right and left ends are received and the right and left bearings respectively.

A combination scoop and dozer system for a vehicle is also disclosed. The system includes right and left lift arms. Each lift arm may include a proximal end, a proximal portion, a hook shaped distal portion and a distal end. Each proximal portion may be disposed between its respective proximal end and its respective hook shaped distal portion. Each hook shaped distal portion may be disposed between its respective distal end and its respective proximal portion. The right and left lift arms may be coupled together by a distal cross beam. The proximal ends of the right and left lift arms may be coupled together by a proximal cross beam. The proximal cross beam may be connected to the vehicle. The system may also include right and left tilt cylinders, right and left tilt levers and right and left cylinder brackets. The right tilt lever may be pivotally coupled to the proximal end of the right lift arm. The left tilt lever may be pivotally coupled to the proximal end of the left lift arm. The right cylinder bracket may be coupled to the right lift arm between the proximal and distal ends thereof. The left cylinder bracket may be coupled to the left lift arm between the proximal and distal ends thereof. The right cylinder may be coupled to the right tilt lever and the right cylinder bracket while the left tilt cylinder may be coupled to the left tilt lever and the left cylinder bracket. The right and left tilt levers may be coupled to right and left bearings. The proximal cross beam may include right and left ends respectively while the right and left ends may be received by the right and left bearings respectively. The system may also include a bucket, a dump cylinder, a blade and right and left pitch cylinders. The distal cross beam may be detachably and pivotally connectible to both the blade and the bucket by way of pitch cylinders and a dump cylinder, respectively. The distal ends of the right and left lift arms may be detachably and pivotally connectible to the bucket and the right and left pitch cylinders may be detachably and pivotally connectible to both the right and left lift arms respectively and to the blade.

A method for providing a tiltable scoop assembly mounted to a vehicle and converting the tiltable scoop assembly to a tiltable dozer assembly is also disclosed. The method includes providing a frame, a bucket, a dump cylinder, a blade, and right and left tilt cylinders. The frame may include right and left lift arms, right and left tilt levers, right and left tilt cylinders and right and left cylinder brackets. Each lift arm may include a proximal end, a proximal portion and a hook shaped distal portion with a proximal portion being disposed between its proximal end and its hook shaped distal portion and each hook shaped distal portion terminating at a distal end. The right and left tilt levers may be pivotally connected to the proximal ends of the right and left lift arms respectively. The right and left cylinder brackets may be connected to the right and left lift arms respectively between the proximal and distal ends thereof. The right tilt cylinder may be pivotally coupled to both the right tilt lever and the right cylinder bracket. The left tilt cylinder may be pivotally coupled to both the left tilt lever and the left cylinder bracket. The right and left lift arms may be coupled together by a distal cross beam and a proximal cross beam. The proximal cross beam is fixedly connected to the vehicle. The bucket may also include right and left side walls. The method may further include detachably connecting the distal ends of the right and left lift arms to the right and left side walls of the bucket respectively, detachably connecting the distal cross beam to one end of the dump cylinder and detachably connecting the other end of the dump cylinder to the bucket to form the scoop assembly. The method may also include disconnecting the right and left lift arms from the side walls of the bucket and disconnecting the dump cylinder from the bucket and the distal cross beam. The method may also include providing a blade including a front and a rear and providing right and left pitch cylinders. The method may also include detachably connecting the rear of the blade to the distal cross beam and detachably connecting the right pitch cylinder between the right cylinder bracket and the rear of the blade and detachably connecting the left pitch cylinder to the left cylinder bracket and to the rear of the blade to provide the dozer assembly.

In any one or more of the embodiments described above, the right and left bearings may be right and left spherical bearings respectively.

In any one or more the embodiments described above, the right and left ends of the proximal cross beam may be right and left trunnions respectively.

In any one or more the embodiments described above, the right and left spherical bearings may provide a translational degree of freedom for maintaining the right and left ends of the proximal cross beam within the right and left spherical bearings respectively when the right and left lift arms are tilted.

In any one or more the embodiments described above, the right and left spherical bearings may each include a housing and a bearing insert for receiving one of the trunnions or one of the ends of the proximal cross beam. Each housing may provide freedom for its respective bearing insert to slide within its respective housing when the proximal ends of the right and left lift arms are tilted.

In any one or more the embodiments described above, the distal cross beam may include a first bracket for connecting a blade and a second bracket for connecting a dump cylinder of a bucket.

In any one or more the embodiments described above, the distal ends of the right and left lift arms may be detachably and pivotally connected to the bucket.

In any one or more the embodiments described above, the distal ends of the right and left lift arms may include a through hole for detachably and pivotally connecting the right and left lift arms to the bucket.

In any one or more the embodiments described above, the right and left cylinder brackets may include right and left links that pivotally connect the right and left tilt cylinders to the right and left cylinder brackets respectively. The right link may be sufficiently long enough to detachably and pivotally connect both a right pitch cylinder and the right tilt cylinder to the right cylinder bracket. The left link may be sufficiently long enough to detachably and pivotally connect both the left pitch cylinder and the left tilt cylinder to the left cylinder bracket.

### BRIEF DESCRIPTION OF THE DRAWINGS

FIG. 1 is a rear perspective view of a prior art scoop assembly shown in a dump position.

FIG. 2 is a rear perspective view of a disclosed scoop assembly shown in a dump position.

FIG. 3 is another rear perspective view of the disclosed scoop assembly shown in FIG. 2 with the bucket in a rest position.

FIG. 4 is a front perspective view of the scoop assembly shown in FIGS. 2-3, with the bucket in a rest position.

FIG. 5 is an exploded view of the scoop assembly disclosed in FIGS. 2-4, particularly illustrating the ease in which the bucket may be removed from the frame.

FIG. 6 is a rear perspective view of the frame shown in FIGS. 2-5 with a blade attached to the frame, particularly illustrating the ease in which one can convert from use of a bucket (FIGS. 2-5) to use of a blade with the disclosed frame

FIG. 7 is a partial rear perspective view of the frame and blade illustrated in FIG. 6, particularly illustrating the coupling of the pitch cylinders between the blade and the right cylinder bracket, which may also be used to support the right tilt cylinder which may extend between the right cylinder bracket and the right lever as shown in FIG. 7.

FIG. 8 is a side plan view of the frame and blade illustrated in FIGS. 6-7 with the pitch cylinders in a retracted position.

FIG. 9 is another side plan view of the frame and blade shown in FIGS. 6-8, with the pitch cylinders in a fully extended position thereby permitting the blade to dig below the ground line.

FIG. 10 is a side plan view of a disclosed scoop assembly with the bucket in a rest position.

FIG. 11 is a side view of a prior art scoop assembly with the bucket in a rest position.

FIG. 12 is a side view of a disclosed scoop assembly with the bucket in a dump position.

FIG. 13 is a side view of a prior art scoop assembly with the bucket in a dump position.

FIG. 14 is a side view of the disclosed scoop assembly with the bucket in a combination dozing and dumping position with the cutting edge of the bucket disposed below ground level.

FIG. 15 is a side view of a prior art scoop assembly in a combination dozing and dumping position.

FIGS. 16-17 illustrate the disclosed scoop assembly in a mid-tilt-left position (FIG. 16) and a mid-tilt-right position (FIG. 17) wherein the mid-tilt positions may be obtained by extending or retracting one of the tilt cylinders only.

FIGS. 18-19 are rear views of the disclosed scoop assembly in a max-tilt-left position (FIG. 18) and a max-tilt-right position (FIG. 19), both of which require retraction of one tilt cylinder and extension of the other tilt cylinder.

FIGS. 20-21 are rear views of the disclosed frame and blade in the mid-tilt-right position (FIG. 20) and the mid-tilt-left position (FIG. 21), both of which may be obtained by extending or retracting one tilt cylinder or a combination of two tilt cylinders.

FIGS. 22-23 illustrate the disclosed frame and blade in the max-tilt-left position (FIG. 22) and the max-tilt-right position (FIG. 23), both of which may be obtained by extending one tilt cylinder and retracting the other tilt cylinder.

FIGS. 24-25 illustrates the differences in the distances between the bearing assemblies when the frame is in the max-tilt-left position (FIG. 24) and a level or no-tilt position (FIG. 25).

FIG. 26 is a plan view of a disclosed proximal cross beam.

FIG. 27 is a plan view of a prior art frame for connecting a bucket to a machine, and which particularly illustrates the problems associated with the tilt mechanism, particularly the max-tilt position which causes the proximal portions of the lift arms to be deflected inward.

FIG. 28 is a partial view of a disclosed frame equipped with a spherical bearing and housing that provides freedom for lateral movement of the spherical bearings with respect to the trunnions attached to the proximal cross beam during a tilting of the frame.

FIG. 29 is an enlarged view of the spherical bearing and housing shown in FIG. 28.

FIG. 30 is a front plan view of the spherical bearing and housing shown in FIGS. 28-29.

FIGS. 31-32 are partial views of the disclosed bucket assemblies, particularly illustrating the pivotal movement of the disclosed spherical bearing and housing (with the cover portion removed), as mounted on the right tilt lever and showing the right tilt cylinder in a fully extended position (FIG. 31) and a fully retracted position (FIG. 32).

### DETAILED DESCRIPTION

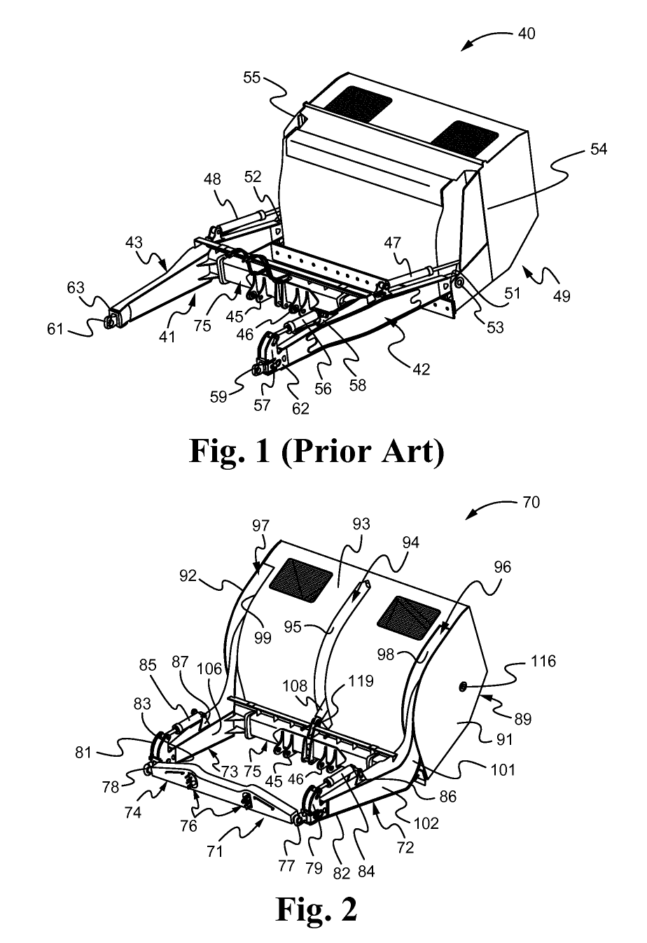

Comparing FIGS. 1 and 2, two scoop assemblies 40, 70 are disclosed respectively. The prior art scoop assembly 40 may include an H-shaped frame 41 that may include a right lift arm 42, a left lift arm 43 and a cross beam 75. The cross beam 75 may include brackets 45, 46 for coupling to a pair of lift cylinders (not shown). The scoop assembly 40 may also include right and left dump cylinders 47, 48 respectively which will cause the bucket 49 to pivot about the distal ends 51, 52 of the lift arms 42, 43 respectively. Specifically, pins, one of which is shown at 53, may connect the distal ends 51, 52 of the lift arms 42, 43 to the right and left sides 54, 55 of the bucket 49. Also shown in FIG. 1 is a tilt cylinder 56, which may be coupled to a tilt lever 57 and a cylinder bracket 58.

In FIG. 1, only a single tilt cylinder 56 is utilized and conventional bearings 59, 61 are utilized which cause the proximal ends 62, 63 of the right and left lift arms 42, 43 respectively to deflect inward as the scoop assembly 40 is tilted because of the difference in distances between the bearings 59, 61. Specifically, the distance between the bearings 59, 61 in a no-tilt condition is shorter than when the frame is tilted by way of movement of the bearing 59 due to its attachment to the tilt lever 57. As a result, the scoop assembly 40 in FIG. 1 with its use of a single tilt cylinder 56 has a limited tilt magnitude ranging from about 2° to about 3°.

Turning to FIG. 2, a disclosed scoop assembly 70 is shown that may include a frame 71 that may include right and left lift arms 72, 73 that may be coupled together by two cross beams, including a proximal cross beam 74 and a distal cross beam 75. The proximal cross beam 74 may be fixed to the machine as indicated by the plurality of fasteners shown at 76. The proximal cross beam may also be coupled to the right and left lift arms 72, 73 by spherical bearing assemblies 77, 78 which may be coupled to the right and left tilt levers 79, 81 respectively. The right and left tilt levers 79, 81 may be coupled to the proximal ends 82, 83 of the right and left lift arm 72, 73 respectively. The right and left tilt levers 79, 81 may be used to support right and left tilt cylinders 84, 85 respectively. The right and left tilt cylinders 84, 85 may also be supported by right and left cylinder brackets 86, 87 respectively. Again, the brackets 44, 45 disposed on the distal cross beam 75 may be utilized for coupling the scoop assembly 70 to lift cylinders (not shown).

Still referring to FIG. 2, the scoop assembly 70 also may include a bucket 45 which may include a right wall 91, a left wall 92 and a curved wall 93 extending therebetween. The curved wall 93 may include a central pocket 94 with a rear opening 95. The curved wall 93 may also form right and left pockets 96, 97 respectively, both with rear openings 98, 99 respectively. The right pocket 96 may accommodate a distal portion 101 of the right lift arm 72 (see FIG. 5) which also may include a proximal portion 102, a distal end 103 and a proximal end 82. Returning to FIG. 2, the left pocket 97 may accommodate the distal portion 105 of the left lift arm 73, which also may include a proximal portion 106, a distal end 107 and a proximal end 83 as shown in FIG. 5.

Returning to FIG. 2, the central pocket 94 may accommodate the single dump cylinder 108 which may extend between the distal cross beam 75 and the inside of the central pocket 94. By placing the dump cylinder 108 inside the central pocket 94, the dump cylinder 108 is not exposed to dirt, debris, etc. as the dump cylinder is not in the path of material flow. Specifically, the dump cylinder 108 is positioned above the path of material flow which avoids packing of material between the dump cylinder 108 and any portion of the frame or any portion of the central pocket 94.

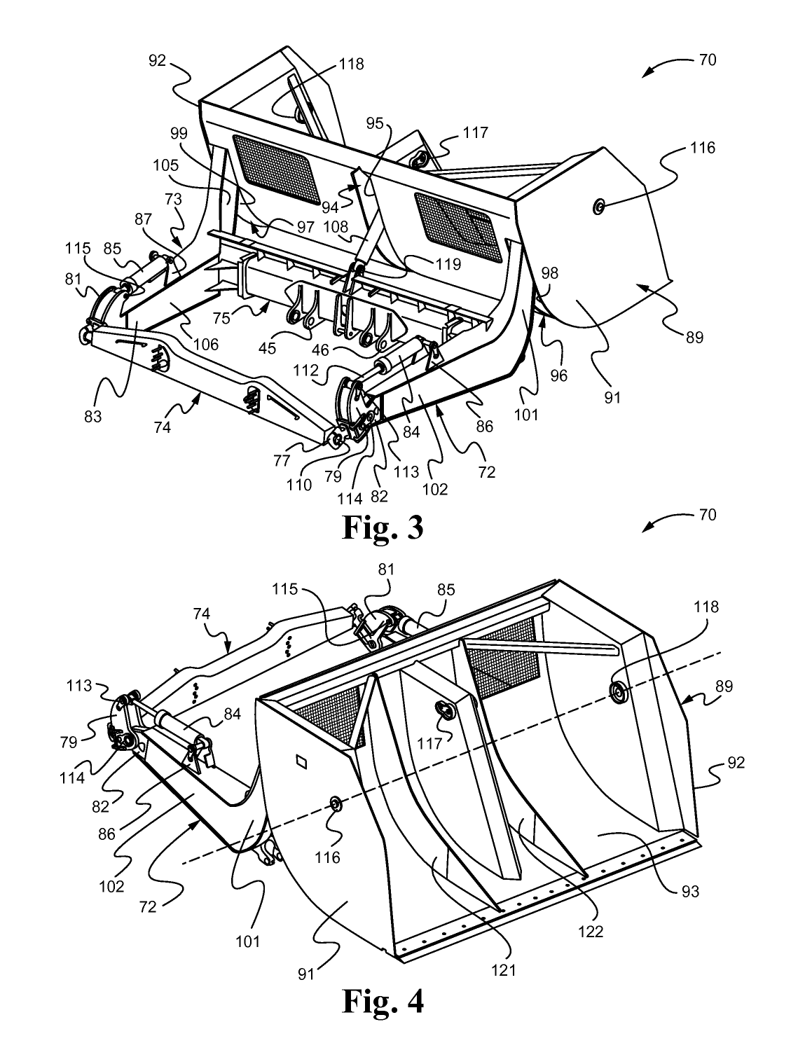

While FIG. 2 illustrates the scoop assembly 70 in a dump position, FIGS. 3 and 4 illustrate the scoop assembly 70 in a tilted position. Specifically, in FIGS. 3 and 4, the right tilt cylinder 84 may be extended and the left tilt cylinder 85 may be retracted. As one can see in FIGS. 3 and 4, with the right tilt cylinder 84 extended, the tilt lever 79 must pivot away from the cylinder 84 due to the fixed position of the right cylinder bracket 86. The reader will also note that bearing assembly 77 receives the right trunnion 110 of the proximal cross beam 74 (see FIG. 26), which also may include a left trunnion 111. Returning to FIGS. 3 and 4, the right tilt lever 79 may be coupled to the rod 112 that extends from the right tilt cylinder 84 by the link 113. The right tilt lever 79 may also be coupled to the proximal end 82 of the lift arm 72 by the link 114. Because the bearing assembly 77 supports the back of the right tilt lever 79 on the trunnion 110, as the rod 112 pushes the link 113 and the top of the right tilt lever 79 rearward or towards the proximal cross beam 74, the lower link 114 and the bottom of the tilt lever 79 pivot upward thereby raising the right lift arm 72.

In contrast, referring to the action of the left tilt cylinder 85, when the left tilt cylinder 85 is retracted, the link 115 and the top of the left tilt lever 81 moves forward and downward thereby causing the lower end (not shown in FIGS. 3-4) of the left tilt lever 81 that is coupled to the proximal end 83 of the left lift arm 73 to move downward thereby lowering the left lift arm 73 as the right lift arm 72 is raised. Also shown in FIGS. 3 and 4 are the links 116, 117, 118 that may be used to couple the right lift arm 72, dump cylinder 108 and left lift arm 73 to the right pocket 96, central pocket 94 and left pocket 97 respectively. FIG. 4 also illustrates the stiffening ribs 121, 122 disposed in the curved wall 93 of the bucket 45.

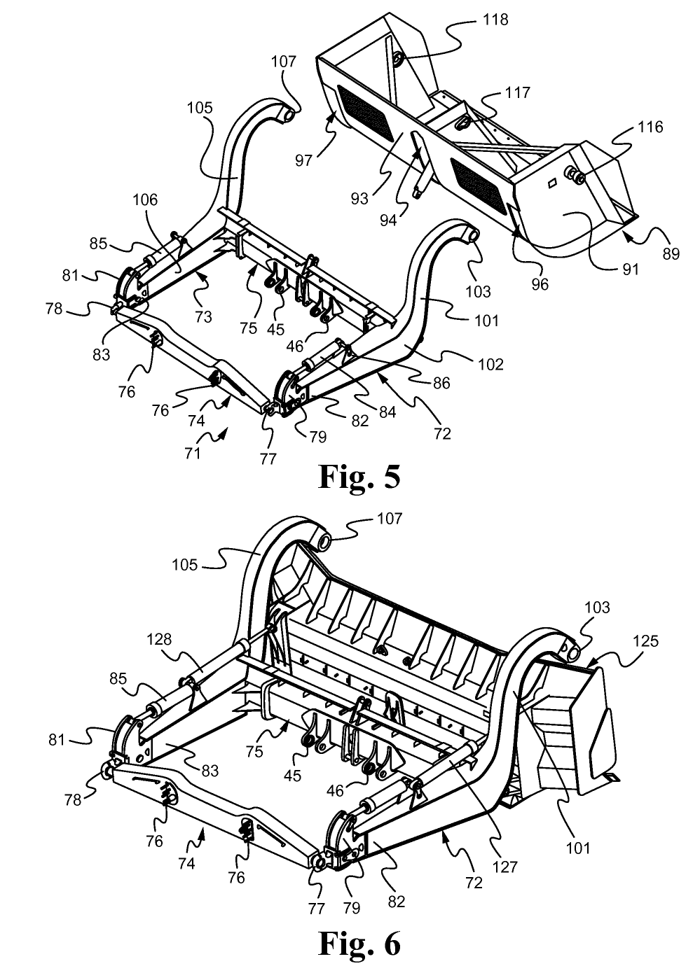

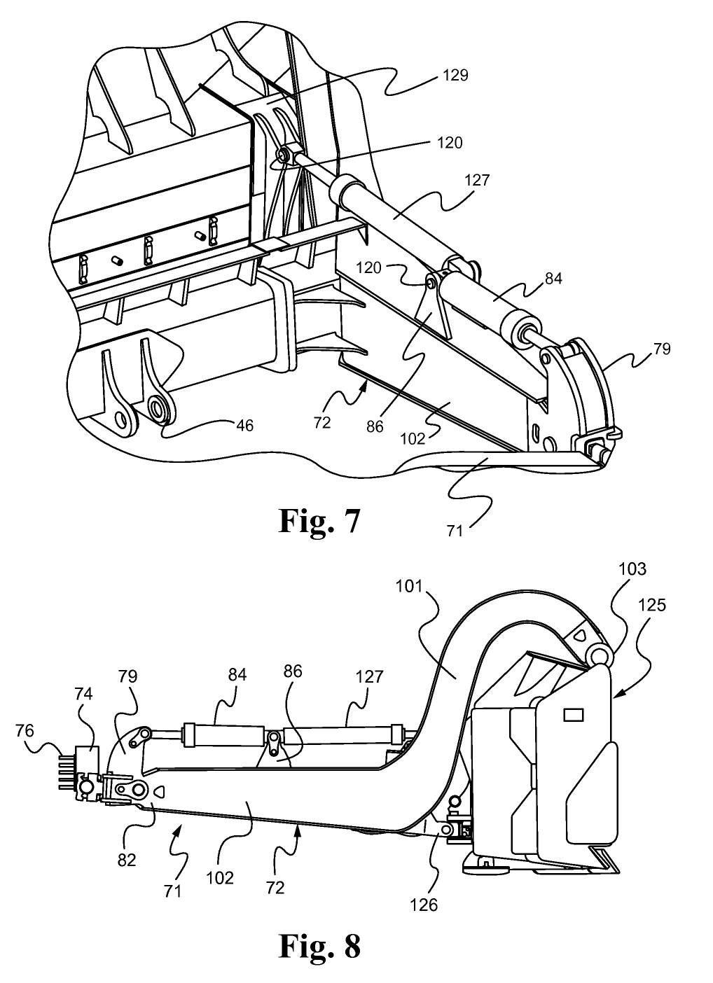

Turning to FIGS. 5 and 6, the ease in which the bucket 45 may be removed from the frame 71 is illustrated. Specifically, a pin may be removed that decouples the dump cylinder 108 from the dump cylinder bracket 109. Also, the pins 116, 118 that bridge the right and left pockets 96, 97 are removed thereby releasing the distal ends 103, 107 of the right and left lift arms 72, 73 from the bucket 45. With the bucket 45 removed, the blade 125 may be installed on the frame 71. Specifically, the front of the distal cross beam 75 may include a clevis 126 or other type of bracket or fixture for coupling to the rear of the blade 125 as illustrated in FIG. 8. Returning to FIG. 6, the blade may be further secured to the right and left lift arm 72, 73 by the right and left pitch cylinders 127, 128 respectively. The pitch cylinders 127, 128 may be secured to mounts 129 (FIG. 7), 131 (FIG. 6) as well as the right and left cylinder brackets 86, 87, which may also support the right and left tilt cylinders 84, 85 respectively.

Thus, the three links are removed to decouple the bucket 45 from the frame 71. Specifically, the links 116, 118 that secure the proximal ends 103, 107 of the right and left lift arms 72, 73 to the right and left pockets 96, 97 are removed as is the link 119 that secures the dump cylinder 108 to the bracket 109. Further, to secure the blade 125 to the frame 71, the clevis 126 (FIG. 8) may be coupled to the rear of the blade 125 and the pitch cylinders 127, 128 are installed using a total of four pins 120 (see FIGS. 6 and 7), two of which are already in place on the right and left cylinder brackets 86, 87. Thus, the transition between the bucket 45 and the blade 125 is fast and straight forward.

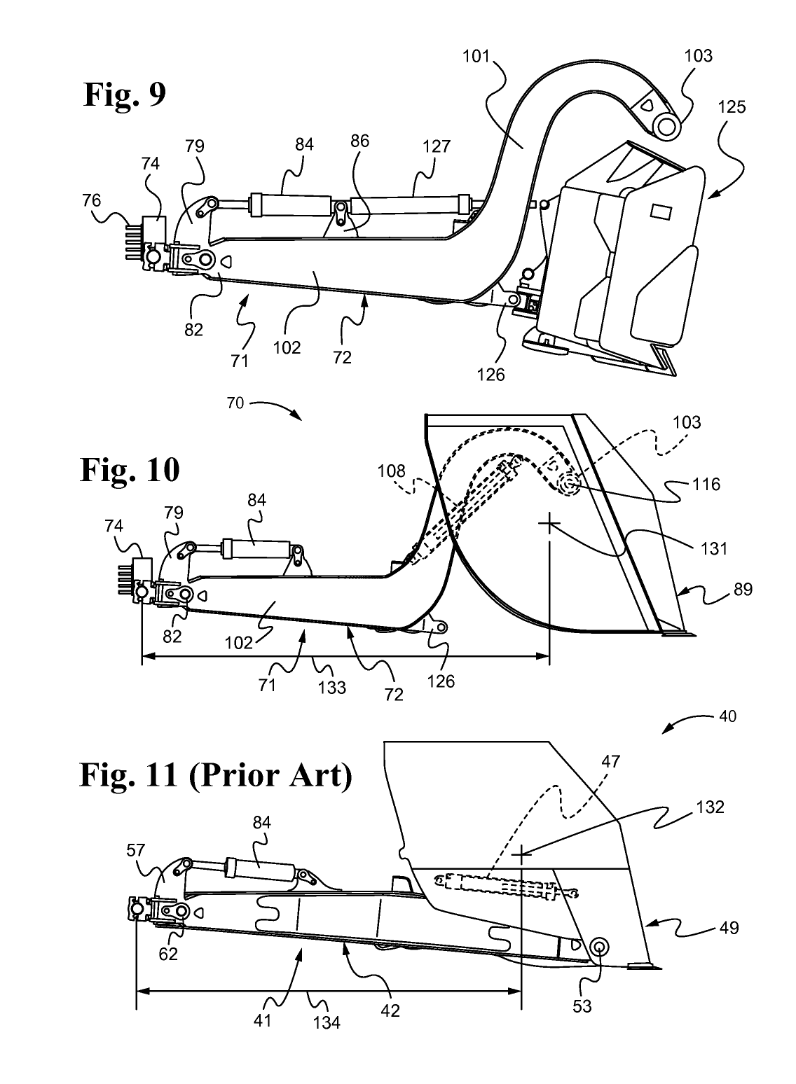

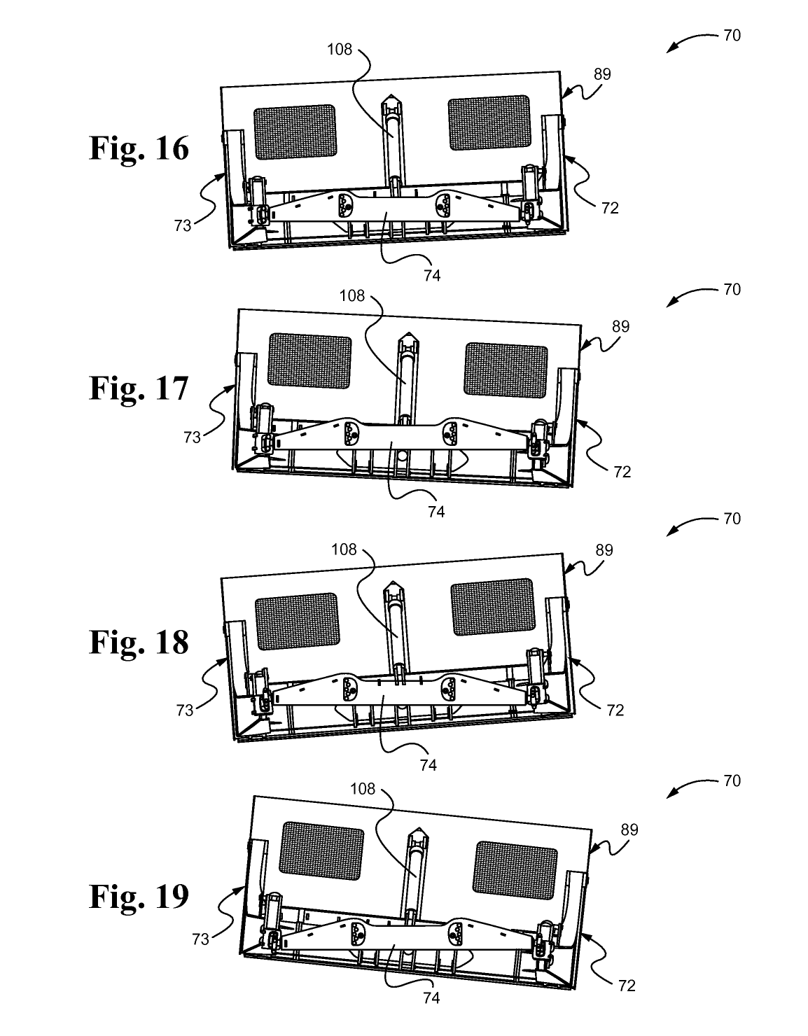

FIGS. 8 and 9 illustrate the frame 71 and blade 125 in the upright (FIG. 8) and pitched forward (FIG. 9) positions. Thus, the blade 125 may be installed with its full pitch function provided by the pitch cylinders 127, 128 in addition to a full tilt function provided by the tilt cylinders 84, 85 as explained in greater detail below in connection with FIGS. 16-32.

Returning to FIGS. 10-11, a comparison of the disclosed frame 71 with the S-shaped profile and the prior art frame 41 with the H-shaped profile (from a top view) is provided. Specifically, the S-shape profile of the lift arms 72, 73 raise the distal ends 103, 107 (FIG. 5) as well as the dump cylinder above ground level and above the proximal portions 102, 106 of the lift arms 72, 73. Because the dump cylinder 108 is disposed higher than the dump cylinders 47, 48 of the scoop assembly 40 (FIG. 11) and further because the dump cylinder 108 (FIG. 10) is out of the flow path of material and debris, there is very little chance that material and debris may be packed between the dump cylinder 108 and the central pocket 95 (FIG. 3) which thereby avoids binding and potential dump cylinder failure. Referring to FIGS. 1 and 11, it is clear that the dump cylinders 47, 48 are exposed to flow of material around the bucket 49 which thereby enables material to be packed between the dump cylinders 47, 48 and the lift arms 42, 43 which may cause the cylinders 47, 48 to bind. Further, if one of the dump cylinders 47, 48 begins to bind, the other cylinder may be prone to a premature failure.

Still referring to FIGS. 10 and 11, the center of gravity of the bucket 45 is shown at 131. In contrast, the center of gravity of the bucket 49 is shown at 132. By raising the distal ends 103, 107 of the lift arms 72, 73 upward, the center of gravity 131 also moves upward with respect to the center of gravity 132 and, in fact, for frames of the same size, the center of gravity 131 of the scoop assembly 70 may be about 5% higher than the center of gravity 132 of the conventional scoop assembly 40 when the buckets 45, 49 are in their rest positions. Further, the payload center of gravity 131 may be disposed about 8.5% farther forward or away from the machine (not shown) when the bucket 45 is in the rest position. In other words, the distance represented by the line 133 may be about 8.5% longer than the distance represented by the line 134.

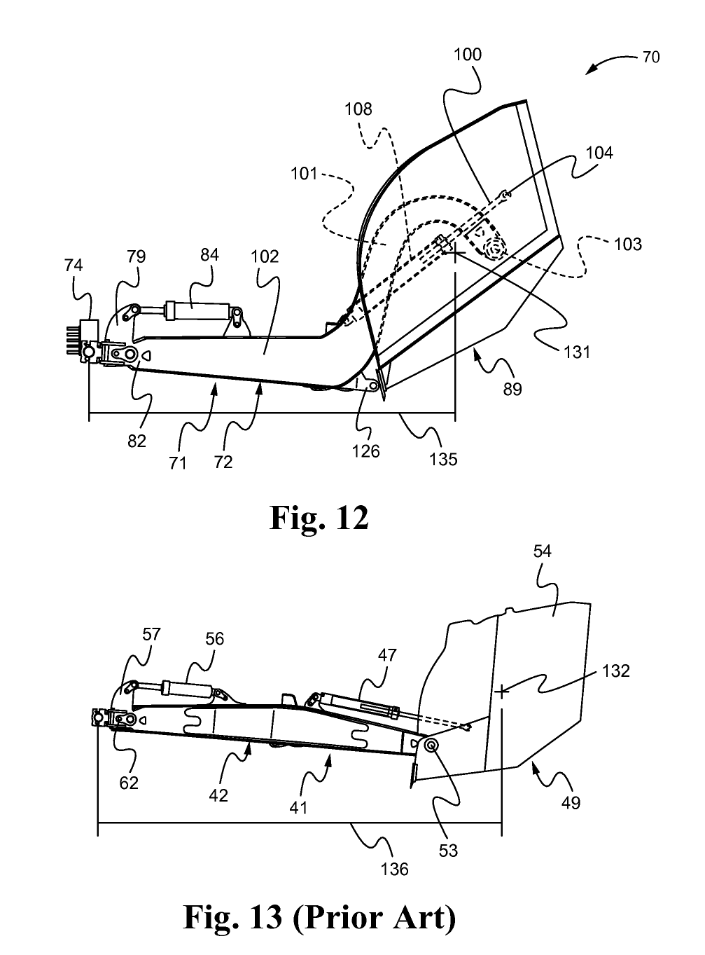

Referring to FIGS. 12-13, the capital S-shaped profile of the arms 72, 73 provides an additional advantage wherein, in the dump position, as shown in FIGS. 12-13, the center of gravity 131 for the bucket 45 of the disclosed scoop assembly 70 may be about 32% closer to the machine than the center of gravity 132 of the bucket 49. By having the center of gravity 131 closer to the machine, a tremendous mechanical advantage may be provided for the lift cylinders (not shown) as less force may be needed to maintain the lift arms 72, 73 in a raised position during a dumping operation. In other words, the distance represented by the line 135 may be about 32% shorter than the distance represented by the line 136. Additionally, a tremendous mechanical advantage may be provided for the return of the bucket to the rest position when the single dump cylinder is fully extended, as the bucket center of gravity would be in a position mechanically favorable for the retraction of the dump cylinder. Further, in the dump position shown in FIGS. 12-13, the center of gravity 131 for the bucket 45 may be 20% higher than the center of gravity 132 for the bucket 49. Thus, the center of gravity 131 may be disposed closer to the machine and at a higher position which provide a tremendous mechanical advantage for the lift cylinders (not shown) over the currently available design as illustrated in FIG. 13.

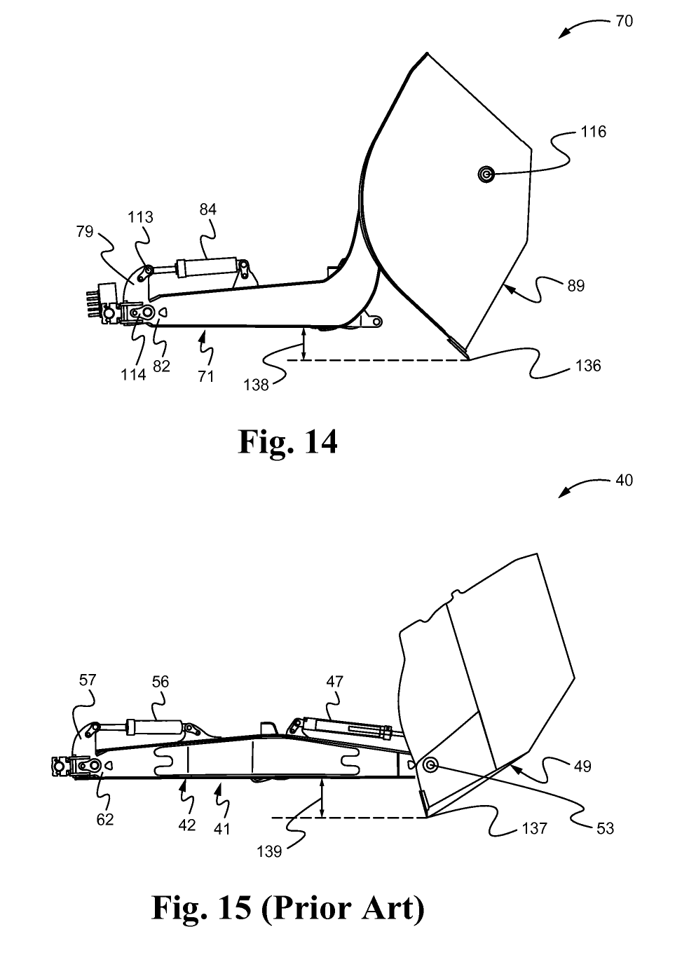

Turning to FIGS. 14-15, the scoop assemblies 70, 40 are shown in their respective dozing positions with the cutting edges 136, 137 respectively disposed below the bottom of their respective frames 71, 41. However, the cutting edge 137 of the bucket 49 may be disposed approximately 32% deeper than the cutting edge 136 of the bucket 45. In other words, the distance represented by the line 138 is approximately 32% shorter than the distance represented by the line 139.

Referring to FIGS. 2-3 and 16-19, the mechanisms for tilting the bucket 45 with respect to the stationary proximal cross beam 74 is illustrated. Turning first to FIG. 2, both tilt cylinders 84, 85 are disposed in a neutral position while the bucket 45 is disposed in a dump position with the dump cylinder 108 fully extended. In FIG. 3, the dump cylinder 108 has been retracted, but the bucket 45 is in a tilted left position. Specifically, as explained above in connection with FIG. 3, the right tilt cylinder 84 has been extended, thereby raising the right lift arm 72 while the left tilt cylinder 85 has been retracted, thereby lowering the left lift arm 73. As the right tilt cylinder 84 is extended, the top or, specifically the link 113 of the tilt lever 79 will be pushed rearward and downward, which causes the lower link 114 of the tilt lever 79 to pivot upward as shown in FIG. 3. Thus, extension of the right tilt cylinder 84 results in a raising of the right lift arm 72 and a tilt of the bucket to the left. A tilt to the left is also provided by retraction of the left tilt cylinder 85 which causes the tilt lever 81 to pivot forward and downward thereby causing the lower link 123 (not shown in FIG. 3, see FIG. 4) of the tilt lever 81 to pull the left lift arm 73 downward. Thus, FIG. 3 represents the scoop assembly 70 in a full-tilt-left position.

In contrast, FIGS. 16-17 illustrate the bucket 45 of the scoop assembly 70 in a mid-tilt-left position (FIG. 16) and a mid-tilt-right position (FIG. 17). To achieve the mid-tilt positions of FIGS. 16-17, where the tilt magnitude ranges from about 2° to about 3°, use of only one tilt cylinder 84 or 85 is needed. In other words, a full extension of the right tilt cylinder will achieve the mid-tilt-left position shown in FIG. 16. Similarly, leaving the right tilt cylinder 84 in a neutral position, a full retraction of the left tilt cylinder 85 will achieve the mid-tilt-left position shown in FIG. 16 as well. Turning to FIG. 17, to achieve the mid-tilt-right position, the left tilt cylinder 85 is fully extended while leaving the right tilt cylinder 84 in a neutral position. Similarly, the right tilt cylinder 84 is fully retracted while leaving the left tilt cylinder 85 in a neutral position to achieve the same mid-tilt-right position shown in FIG. 17.

Turning to FIGS. 18-19, the bucket 45 are shown in full-tilt-left (FIG. 18) and full-tilt-right (FIG. 19) positions. To achieve the full-tilt-left position shown at FIG. 18, the right tilt cylinder 84 is fully extended and the left tilt cylinder 85 is fully retracted. The magnitude of the tilt is about twice that shown in FIG. 16 or within a range of from about 5° to about 6°. Similarly, to achieve the full-tilt-right position shown in FIG. 19, the right tilt cylinder is fully retracted while the left tilt cylinder 85 is fully extended.

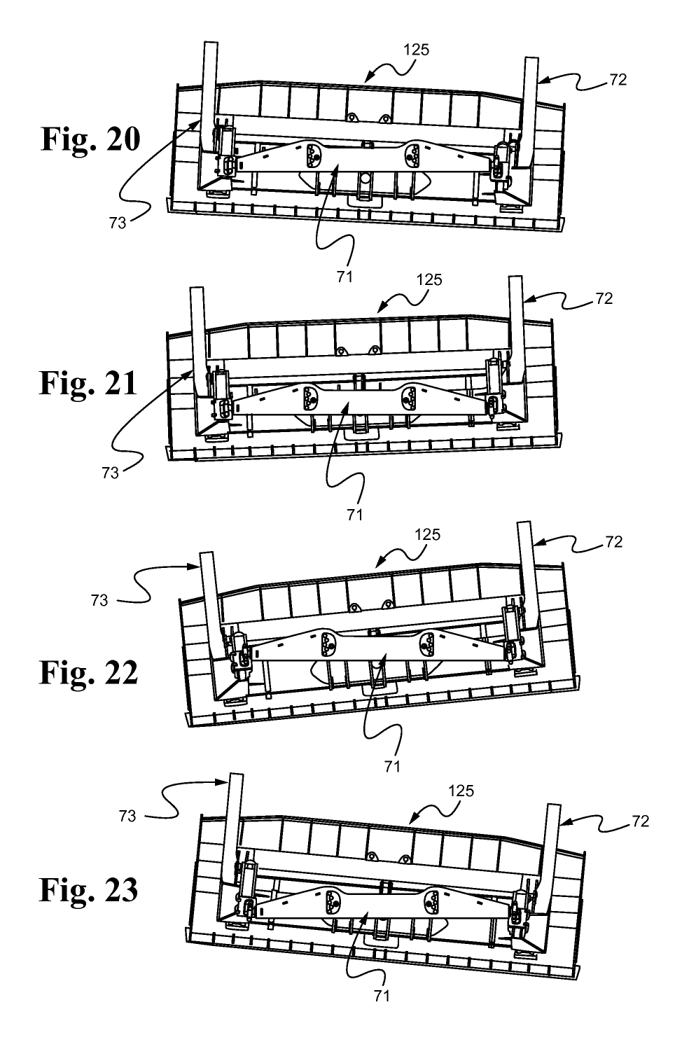

Turning to FIGS. 20-23, the same mid-tilt and full-tilt positions may be achieved with the blade 125 connected to the frame 71. FIG. 20 shows the blade in the mid-tilt-right position, which can be achieved by fully retracting the right tilt cylinder 84, fully extending the left tilt cylinder 85 or using a partial retraction of the right tilt cylinder 84 in combination with a partial extension of the left tilt cylinder 85. To achieve the mid-tilt-left position shown in FIG. 21, the right tilt cylinder 84 may be fully extended, the left tilt cylinder 85 may be fully retracted or a combination of a partial extension of the right tilt cylinder 84 and a partial retraction of the left tilt cylinder 85 may be employed. To achieve the full-tilt-left position shown in FIG. 22, the right tilt cylinder 84 may be fully extended and the left tilt cylinder 85 may be fully retracted. To achieve the full-tilt-right position shown in FIG. 23, the right tilt cylinder 84 may be fully retracted and the left tilt cylinder 85 may be fully extended.

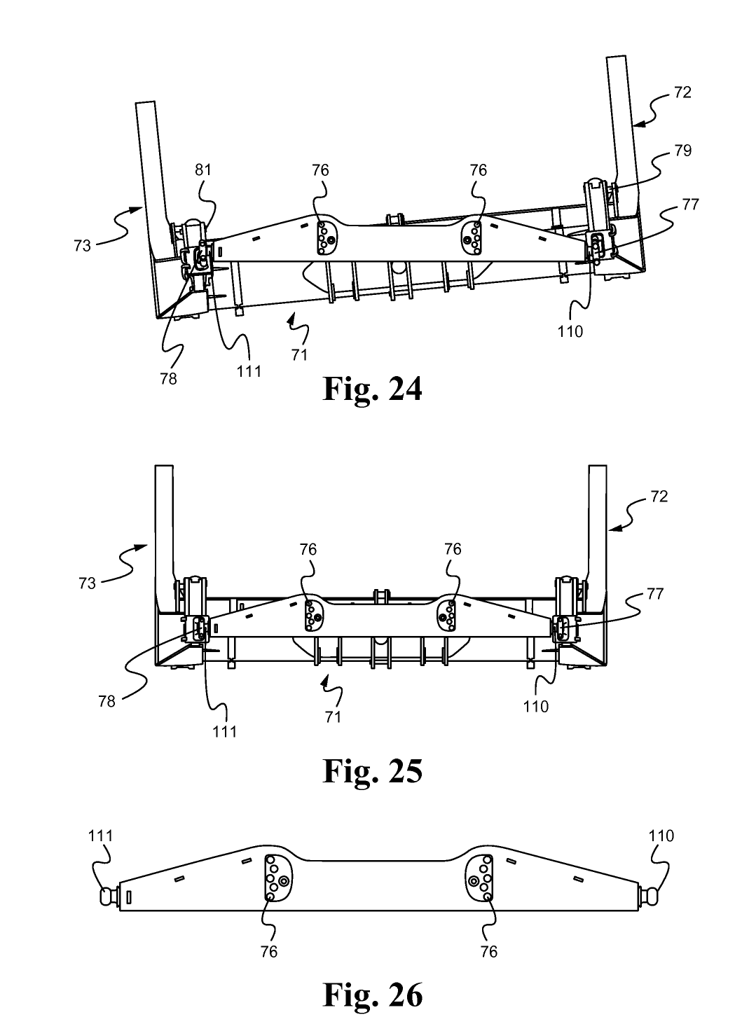

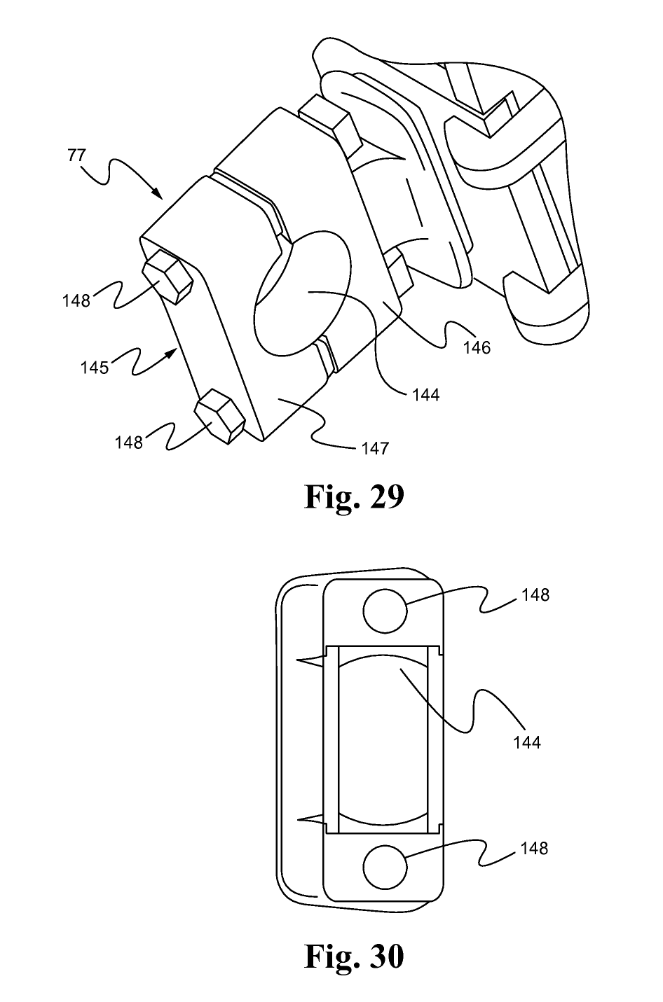

FIGS. 24-32 illustrate the use of spherical bearings 77, 78 for maintaining a connection to the right and left trunnions 110, 111, which are fixed in place as the proximal cross beam 74 is fixed to the machine (not shown). Specifically, when the frame 71 is tilted to the left, for example, as in FIG. 24, the distance between the spherical bearings 77, 78 increases as the spherical bearings 77, 78 are no longer axially aligned with the right and left trunnions 110, 111 as illustrated in FIG. 25. To compensate for this increased distance, which may be low in terms of the percentage of the distance between the trunnions 110, 111, but which may still be a significant amount, e.g. about 18 mm, spherical bearings 77, 78 are employed which allow the bearings 77, 78 to move within the spherical bearing housing 145 as the arms 72, 73 are tilted. As shown in FIG. 29, the bearing housing 145 may include a bottom half 146 and a top half 147. The bottom and top halves 146, 147 are secured together by a pair of fasteners 148 with the bearing insert 175 sandwiched between the housing halves 146, 147.

Returning to FIGS. 24-27, the distance between the trunnions 110, 111 of the proximal cross beam 74 is, of course, fixed. Further, the position of the cross beam 74 is fixed as it may be mounted to the machine using the fasteners 76. However, when the frame 71 may be tilted, as shown in FIG. 24, the distance between the spherical bearings 77, 78 has increased as the left tilt lever 81 has pivoted forward and downward, carrying the spherical bearing assembly 78 with it and thereby driving the left tilt arm 73 downward. Simultaneously, the right tilt lever 79 has been pushed rearward by the extension of the right tilt cylinder 84 thereby causing the bottom of the right tilt lever 79 to push the lift arm 72 upward as shown in FIG. 24. Thus, due to the movement of the tilt lever 79, 81, the distance between the spherical bearings 77, 78 has increased as the spherical bearings 77, 78 are mounted to the tilt levers 79, 81. To compensate for this additional distance, and to maintain the trunnions 110, 111 within the spherical bearings 77, 78, the spherical bearing inserts 175 must permit the spherical bearing inserts 175 to slide outwardly with respect the trunnions 110, 111. By providing this additional clearance or “play”, no torque is applied to the frame 71.

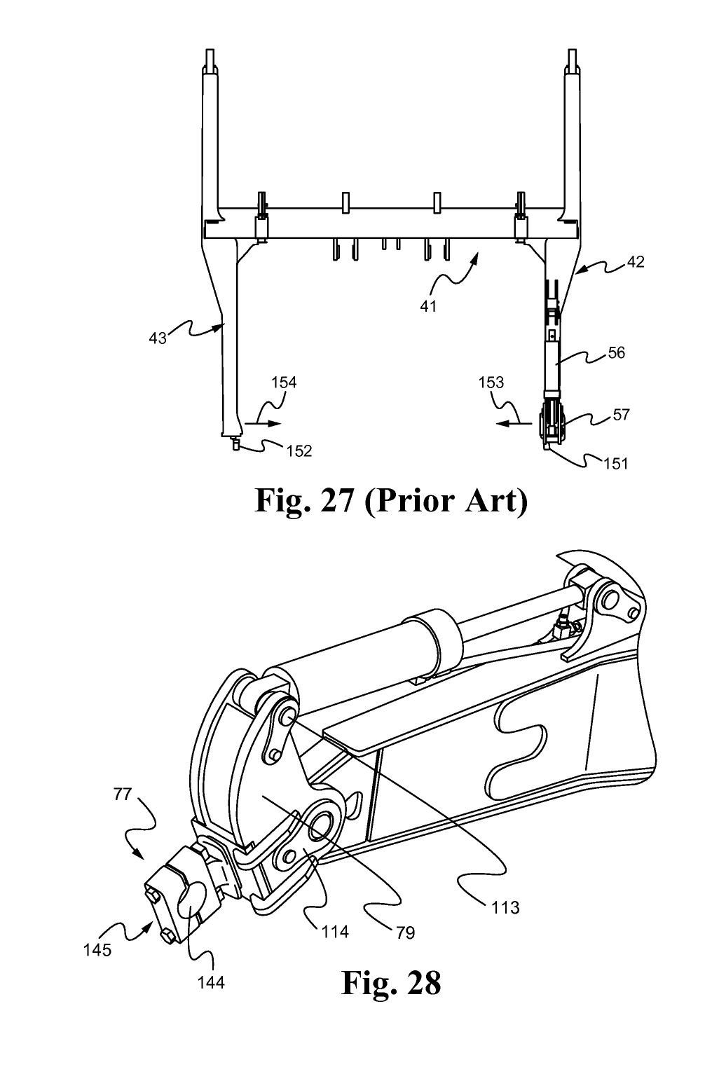

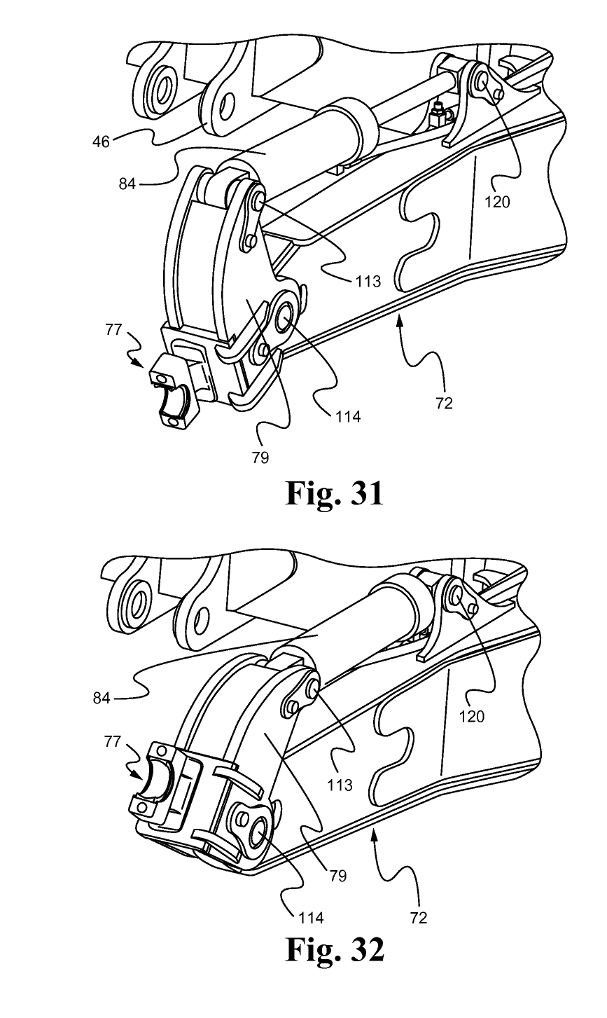

In contrast, referring to the prior art H-shaped frame 41 shown in FIG. 27, the frame 41 may include only a single tilt cylinder 56 and a single tilt lever 57. Use of a single cylinder 56 and a single lever 57 results in a moderate expansion of the distance between the conventional bearings 151, 152. However, because the trunnions 110, 111 or the end of the proximal crossbeam 74 are trapped within the bearings 151, 152, tilting the frame 41 causes the lift arms 42, 43 to be deflected inward toward each other, or in the direction of the arrows 153, 154. The additional stresses caused by the use of a second tilt cylinder will generate too much inward defective pressure on the lift arms 42, 43. As a result, the prior art frame 41 shown in FIG. 27 is only capable of tilting from about 2° to about 3° while the disclosed frame 71 is capable of tilting to within a max-tilt range of from about 5° to about 6°. The extent to which the elevation or vertical position of the spherical bearing 77 changes with respect to the lift arm 72 is illustrated in FIGS. 28 and 31. Simply put, the change in the vertical position of spherical bearing 77 is a result of the pivoting action of the tilt lever 79. The position of the tilt lever 79 in FIG. 31 along with the extension of tilt cylinder 84 results in the upward pivotal movement of the link 114 disposed at the bottom of the tilt lever 79, which thereby raises the lift arm 72. In contrast, the contraction of the tilt cylinder 84 results in a forward pivotal movement of the link 113 and downward pivotal movement of the link 114, thereby causing the right lift arm 72 to be lowered.

### INDUSTRIAL APPLICABILITY

The disclosed scoop assembly 70 provides a number of benefits over the prior art scoop assembly 40 with the typical H-shaped frame 41. For example, by positioning the dump cylinder 108 above the center of distal cross beam 75 and above the proximal portions 102, 106 of the lift arms 72, 73 and/or by disposing the dump cylinder 108 within a central pocket 94 in the curved wall 93 of the bucket 45, the dump cylinder 108 may be protected from material flow which thereby eliminates the potential for chip and coal packing between the dump cylinder and a portion of the frame or a surface of the pocket 94. The packing of wood chips and coal between a cylinder and a frame can cause cylinder damage and failure.

Further, the disclosed scoop assembly 70 requires only a single dump cylinder 108 as opposed to dual dump cylinders 47, 48 of prior art designs.

Also, by providing the hook-shaped distal portions 101, 105 of the lift arm 72, 73, the distal ends 103, 107 of the lift arms 72, 73 are raised as are the positions of the attachment pins 116, 118 on the bucket 45. The raised positions and resulting geometry constrict the position payload of the center of gravity 131. While the center of gravity 131 may be farther away from the machine than the center of gravity 132 while the buckets 79, 49 are in a resting position as shown in FIGS. 10-11 respectively, in the dump position, the center of gravity 131 may be a full 32% closer to the machine or dozer than the center of gravity 132 as illustrated in FIGS. 12-13. By placing the bucket payload center of gravity 131 closer to the machine, a drastic reduction of the shifting of the payload center of gravity 131 occurs as the load is being dumped. This is made possible by relocation of the dump cylinder 108 and the dump cylinder pin 104 closer to the payload center of gravity 131. The disclosed scoop assembly 70 also eliminates the potential of “bucket overrun”, which has the tendency to pull the dump cylinder rod 100 (FIG. 12) out of the dump cylinder 108 when a load is being dumped. The scoop assembly 70 makes this possible by shifting the payload center of gravity 131 closer to the dump cylinder 108 when the bucket 45 is in the dump position as illustrated in FIG. 12.

In summary, as illustrated in FIGS. 10-11, the higher position of the center of gravity 131, along with its more forward position in the bucket rest position results in a mechanical advantage for the frame 71 of the disclosed scoop assembly 70 of at least 5%. Further, as illustrated in FIGS. 12-13, when the bucket 45 is in a dump position, the mechanical advantage is at least 20% as the center of gravity 131 is disposed closer to the machine than the center of gravity 132 for the conventional scoop assembly 40. In one example, the center of gravity 131 for the disclosed scoop assembly 70 is about 32% closer to the machine than the center of gravity 132 as illustrated in FIGS. 12-13.

Further, when dumping the bucket 45, the cutting edge 136 of the bucket 45 will dip below the frame 71, but not as far below the frame as in the prior art design represented by the H-shaped frame 41. Specifically, the cutting edge 136 drops about 24% less than the cutting edge 137 of the bucket 49 as illustrated in FIGS. 14-15.

Also, the two tilt cylinders 84, 85 provided with the scoop assembly 70 enables twice the tipping angle (from about 5° to about 6° as opposed to from about 2° to about 3°) for the bucket 45 as well as the blade 125. This is made possible by the use of spherical bearings 77, 78 which provide a degree of translational freedom to account for the greater distances between the spherical bearings 77, 78 when the frame 71 is in a tilted position with respect to the proximal cross beam 74.

Another advantage provided by the scoop assembly 70 is that its bucket 45 may be quickly and easily replaced by a standard blade 125 as illustrated in FIGS. 5-6. The blade 125 may also be equipped with the full range of pitch angles by supplying dual pitch cylinders 127, 128, which may also be mounted to the right and left cylinder brackets 86, 87 with the tilt cylinders 84, 85 as illustrated in FIG. 6. The full range of the tilt capability of the blade 125 is illustrated in FIGS. 20-23.

In summary, the new frame 71 design with a single raised dump cylinder 108 eliminates debris packing and dump cylinder 108 binding. The new frame 71 design also constricts the range of motion of the payload center of gravity 131 and draws the payload center of gravity 131 closer to the machine for improved bucket performance. A standard blade 125 may be easily attached directly to the frame 71 for added versatility in coal and chip working operations. The full range of pitch and role motions of the blade 125 are enabled by the disclosed frame 71. The spherical bearings 77, 78 with the translational degree of freedom enables an increased tilt range for both the bucket 45 and blade 125.

What is claimed is:

1. A tiltable frame for a combination scoop and dozer system, the frame comprising:
right and left lift arms, each lift arm including a proximal end and a distal end, the right and left lift arms being coupled together by a distal cross beam between the proximal and distal ends of the lift arms, the proximal ends of the right and left lift arms being coupled to a fixed proximal cross beam;
right and left tilt cylinders, right and left tilt levers and right and left cylinder brackets, the right tilt lever being pivotally coupled to the proximal end of the right lift arm, the left tilt lever being pivotally coupled to the proximal end of the left lift arm, the right cylinder bracket being coupled to the right lift arm between the proximal and distal ends thereof, the left cylinder bracket being coupled to the left lift arm between the proximal and distal ends thereof, the right tilt cylinder being coupled to the right tilt lever and the right cylinder bracket, the left tilt cylinder being coupled to the left tilt lever and the left cylinder bracket;
the right and left tilt levers being coupled to right and left bearings, the proximal cross beam including right and left ends, the right and left ends being received in the right and left bearings respectively.

2. The frame of claim 1 wherein the right and left bearings are right and left spherical bearings respectively.

3. The frame of claim 1 wherein the right and left ends of the proximal cross beam are right and left trunnions respectively.

4. The frame of claim 2 wherein the right and left spherical bearings provide a translational freedom along the common axis for maintaining the right and left ends of the proximal cross beam within the right and left spherical bearings respectively when the right and left lift arms are tilted.

5. The frame of claim 2 wherein the right and left spherical bearings each include a housing and a bearing insert for receiving one of the trunnions, each housing providing translational freedom for its respective bearing insert to slide within its respective housing when the proximal ends of the right and left lift arms are tilted.

6. The frame of claim 1 wherein the distal cross beam includes a first set of brackets for connecting to a blade and a second bracket for connecting to a dump cylinder of a bucket.

7. The frame of claim 1 wherein the distal ends of the right and left lift arms are detachably and pivotally connectable to a bucket.

8. The frame of claim 1 wherein the distal ends of the right and left lift arms include a through hole for detachably and pivotally connecting the right and left lift arms to a bucket.

9. The frame of claim 1 wherein the right and left cylinder brackets include right and left links that pivotally connect the right and left tilt cylinders to the right and left cylinder brackets respectively, the right link being sufficiently long enough to detachably and pivotally connect to both a right pitch cylinder and the right tilt cylinder to the right cylinder bracket, the left link being sufficiently long enough to detachably and pivotally connect to both a left pitch cylinder and the left tilt cylinder to the left cylinder bracket.

10. A combination scoop and dozer system for a vehicle, the system comprising:
right and left lift arms, each lift arm including a proximal end, a proximal portion, a hook shaped distal portion and a distal end, each proximal portion being disposed between its respective proximal end and its respective hook shaped distal portion, each hook shaped distal portion being disposed between its respective distal end and its respective proximal portion,
the right and left lift arms being coupled together by a distal cross beam between the proximal and distal ends thereof, the proximal ends of the right and left lift arms being coupled together by a proximal cross beam, the proximal cross beam being connected to the vehicle;
right and left tilt cylinders, right and left tilt levers and right and left cylinder brackets, the right tilt lever being pivotally coupled to the proximal end of the right lift arm, the left tilt lever being pivotally coupled to the proximal end of the left lift arm, the right cylinder bracket being coupled to the right lift arm between the proximal and distal ends thereof, the left cylinder bracket being coupled to the left lift arm between the proximal and distal ends thereof, the right tilt cylinder being coupled to the right tilt lever and the right cylinder bracket, the left tilt cylinder being coupled to the left tilt lever and the left cylinder bracket;
the right and left tilt levers are coupled to right and left bearings, the right and left ends of the proximal cross beam including right and left ends respectively, the right and left ends being received in the right and left bearings respectively;
a bucket, a dump cylinder, a blade and right and left pitch cylinders;
the distal cross beam being detachably and pivotally connectable to both the blade and the dump cylinder;
the distal ends of the right and left lift arms being detachably and pivotally connectable to the bucket; and
the right and left pitch cylinders being detachably and pivotally connectable to both the right and left lift arms respectively and the blade.

11. The system of claim 10 wherein the right and left bearings are right and left spherical bearings respectively.

12. The system of claim 10 wherein the right cylinder bracket is detachably connectable to both the right tilt cylinder and the right pitch cylinder, the left cylinder bracket is detachably connectable to both the left tilt cylinder and the left pitch cylinder.

13. The system of claim 12 wherein the right and left cylinder brackets include right and left links that pivotally connect the right and left tilt cylinders to the right and left cylinder brackets respectively, the right link being sufficiently long enough to detachably and pivotally connect both the right pitch cylinder and the right tilt cylinder to the right cylinder bracket, the left link being sufficiently long enough to detachably and pivotally connect both the left pitch cylinder and the left tilt cylinder to the left cylinder bracket.

14. The system of claim 10 wherein the blade includes a front and a rear, the rear of the blade including right and left mounts, the right and left mounts being detachably and pivotally connectable to the right and left pitch cylinders respectively, the right and left pitch cylinders also being coupled to right and left cylinder brackets respectively with the right and left tilt cylinders respectively.

15. The system of claim 11 wherein the right and left spherical bearings provide translational freedom for maintaining the right and left ends of the proximal cross beam within the right and left spherical bearings respectively when the proximal ends of the right and left lift arms are tilted.

16. The system of claim 15 wherein the right and left spherical bearings each include a housing and a bearing insert for receiving the right and left ends of the proximal cross beam respectively, each housing providing translational freedom for its respective bearing insert to move within its respective housing when the proximal ends of the right and left lift arms are tilted.

17. The system of claim 10 wherein the right and left ends of the proximal cross beam are right and left trunnions respectively.

18. The system of claim 10 wherein the right and left cylinder brackets are disposed on the proximal portions of the right and left lift arms respectively.

19. The system of claim 1 wherein the blade includes a front and a rear, the rear of the blade including right and left mounts, the right and left mounts being pivotally and detachably connectable to the right and left pitch cylinders respectively, the right and left pitch cylinders also being pivotally and detachably coupled to right and left cylinder brackets respectively with the right and left tilt cylinders respectively.

20. A method for providing a tiltable scoop assembly mounted to a vehicle and converting the tiltable scoop assembly to a tiltable dozer assembly, the method comprising:
providing a frame, a bucket, a dump cylinder, a dozer blade and right and left tilt cylinders;
the frame including right and left lift arms, right and left tilt levers, right and left tilt cylinders and right and left cylinder brackets, each lift arm including a proximal end, a proximal portion and a hook shaped distal portion with the proximal portion disposed between its proximal end and its hook shaped distal portion and each hook shaped distal portion terminating at a distal end, the right and left tilt levers being pivotally connected to the proximal ends of the right and left lift arms respectively, the right and left cylinder brackets being connected to the right and left lift arms respectively between the proximal and distal ends thereof, the right tilt cylinder being pivotally coupled to both the right tilt lever and the right cylinder bracket, the left tilt cylinder being pivotally coupled to both the left tilt lever and the left cylinder bracket, the right and left lift arms being coupled together by a distal cross beam and a proximal cross beam, the proximal cross beam being fixedly connected to the vehicle, the bucket including right and left sidewalls;
detachably connecting the distal ends of right and left lift arms to the right and left sidewalls respectively, detachably connecting the distal cross beam to one end of the dump cylinder and detachably connecting the other end of the dump cylinder to the bucket for form the scoop assembly;
disconnecting the right and left lift arms from the right and left sidewalls respectively and disconnecting the dump cylinder from the bucket and distal cross beam respectively;
providing a blade including a front and a rear, and providing right and left pitch cylinders;
detachably connecting the rear of the blade to the distal cross beam;
detachably connecting the right pitch cylinder to the right cylinder bracket and to the rear of the blade;
detachably connecting the left pitch cylinder to the left cylinder bracket and to the rear of the blade to provide the plow assembly.
